(19) United States
(12) Patent Application Publication
(10) Pub. No.: US 2014/0360773 A1
(43) Pub. Date: Dec. 11, 2014

(54) Electrically Insulated Screen And Method Of Erecting An Electrically Insulated Screen

(71) Applicant: Synergy Scaffolding Holdings Pty Ltd., Arncliffe (AU)

(72) Inventors: Hussein Soukie, Arncliffe (AU); Mohamad El Jarrar, Punchbowl (AU); Robert Zaidder, Riverwood (AU); Mohamed Soukie, Arncliffe (AU)

(73) Assignee: SYNERGY SCAFFOLDING HOLDINGS PTY LTD., Arncliffe (AU)

(21) Appl. No.: 14/355,479

(22) PCT Filed: Oct. 23, 2012
(86) PCT No.: PCT/AU2012/001292

§ 371 Date: Apr. 30, 2014

(30) Foreign Application Priority Data
Oct. 31, 2011 (AU) 2011904529
Feb. 27, 2012 (AU) 2012900725

(51) Int. Cl. E04B 1/92; H01B 17/56

(52) U.S. Cl. CPC E04B 1/92; H01B 17/56
USPC 174/5 R; 52/741.3

(57) ABSTRACT

A method of erecting an electrically insulated screen for a metal scaffold in a defined area with live electrical cables, the method comprising the steps of: erecting a first portion of the screen to a first screen height along a first screen length in the defined area; affixing the first portion of the screen in place using a stabilising mechanism; and erecting a first portion of the scaffold to a first scaffold height and a first scaffold length, wherein: the first scaffold height does not exceed the first screen height, the first scaffold length does not exceed the first screen length, and the first portion of the scaffold is erected on a side of the first portion of the screen that is opposite to a side where the live electrical cables are located.

### FIELD OF THE INVENTION

The present invention relates to an electrically insulated screen and method of erecting an electrically insulated screen. In particular, the present invention relates to a method of erecting an electrically insulated screen for a metal scaffold in a defined area with live electrical cables and an electrically insulated screen for protecting a scaffold in a defined area with live electrical cables: Further, the present invention relates to a method of erecting a screen to provide a containment area.

### BACKGROUND

When erecting scaffolding, safety of personnel associated with the scaffolding is paramount. In particular, in environments where live electrical cables are situated in the area where metal scaffolding is to be erected, attention needs to be paid to ensure that the scaffolding, or a person on the scaffolding, does not come into contact with the live electrical cables.

When metal scaffolding is being erected around train lines where power is provided to the trains by overhead live electrical cables, it is common for the electricity to the cables to be disconnected prior to the erection of the scaffolding. However, this can be extremely problematic for the train operators who may require the live electrical cables to be active at most times so that there is no disruption in the train operation timetable.

In order to address this problem, the train operators are required to de-energise the live electrical cables at less inconvenient times such as during the night when the trains have either ceased to run or are only running infrequently. This can cause additional problems for erecting the scaffold as the scaffold is required to be erected when it is dark and so artificial light is required to be generated. This artificial light may not be sufficient to ensure the people erecting the scaffold can comply with the required safety regulations.

Standard hoarding panels are generally made from a wooden or paper-based product. However, when these hoarding panels get wet, such as when it is raining, the panels may become electrically conductive and so have limited use for protecting persons against live electrical cables in wet conditions.

Further, after the metal scaffolding has been erected, an area may be created for work to be carried out within the bounds of the scaffolding. Plastic sheets and such like are usually hung or fixed from the scaffolding to try and provide a barrier between the work area and the area outside where the general public may be located.

However, these types of arrangements may have a number of problems associated with them. For example, the designated work area may not provide protection to workers from electrical systems nearby such that any live cables may still be able to contact the electrically conductive scaffolding and so increase the risk of serious injury or death. Further, these types of arrangements can provide a work area that provides poor working conditions within the work area due to heat being trapped within the area. Also, these types of arrangements only have limited effect in mitigating the risk of contaminating areas outside of the work area.

An object of the present invention is to provide an improved method of erecting scaffolding in an area where live electrical cables are located.

A further object of the present invention is to provide an improved electrically insulated screen for protecting a scaffold.

A further object of the present invention is to provide an improved containment system based around a scaffolding work environment.

Each object is to be read disjunctively with the object of at least providing the public with a useful choice.

The present invention aims to overcome, or at least alleviate, some or all of the afore-mentioned problems.

Further objects and advantages of the invention will be brought out in the following portions of the specification, wherein the detailed description is for the purpose of fully disclosing the preferred embodiment of the invention without placing limitations thereon.

The background discussion (including any potential prior art) is not to be taken as an admission of the common general knowledge in the art in any country. Any references discussed state the assertions of the author of those references and not the assertions of the applicant of this application. As such, the applicant reserves the right to challenge the accuracy and relevance of the references discussed.

### SUMMARY OF THE INVENTION

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components that the use directly references, but optionally also the inclusion of other non-specified components or elements. It will be understood that this intended meaning also similarly applies to the terms mentioned when used to define steps in a method or process.

According to one aspect, the present invention provides a method of erecting an electrically insulated screen for a metal scaffold in a defined area with live electrical cables, the method comprising the steps of: erecting a first portion of the screen to a first screen height along a first screen length in the defined area; affixing the first portion of the screen in place using a stabilising mechanism; and erecting a first portion of the scaffold to a first scaffold height and a first scaffold length, wherein: the first scaffold height does not exceed the first screen height, the first scaffold length does not exceed the first screen length, and the first portion of the scaffold is erected on a side of the first portion of the screen that is opposite to a side where the live electrical cables are located.

According to a further aspect, the present invention provides a method of erecting an electrically insulated screen for a metal scaffold in a defined area with live electrical cables, the method comprising the steps of erecting one or more portions of the screen and subsequently erecting one or more portions of the scaffold, while ensuring that the height of the screen is greater than the height of the scaffold and ensuring that the scaffold is erected on a side of the first portion of the screen that is opposite to a side where the live electrical cables are located.

According to yet a further aspect, the present invention provides an electrically insulated screen for protecting a metal scaffold in a defined area with live electrical cables, wherein the screen comprises: an electrically insulated panel, an electrically insulated frame, one or more connectors to connect the panel to the frame, wherein the connectors are arranged to connect the panel to the frame while ensuring a gap exists between the frame and the panel such that the gap enables an attachment device to engage the frame and attach the screen to the scaffold.

According to yet a further aspect, the present invention provides a method of creating a containment area with screens, the method comprising the steps of: erecting a scaffold system to define an area of containment; attaching a plurality of vertically orientated screens to the scaffold system around the perimeter of the defined area, wherein at least one of the vertically orientated screens has an exit/entry port; and attaching one or more horizontally orientated screens across the top of the scaffold system, wherein neighbouring vertically orientated screens are arranged to overlap with each other.

### BRIEF DESCRIPTION OF THE DRAWINGS

Embodiments of the present invention will now be described, by way of example only, with reference to the accompanying drawings, in which:

FIG. 1 shows a rear view of an electrically insulated screen according to an embodiment of the present invention;

FIG. 2 shows a top view of an electrically insulated screen according to an embodiment of the present invention;

FIG. 3 shows a side view of an electrically insulated screen according to an embodiment of the present invention;

FIG. 4 shows a perspective view of erected electrically insulated screens according to an embodiment of the present invention;

FIGS. 5A-5C show a clamp for erecting electrically insulated screens according to an embodiment of the present invention;

FIG. 6 shows a stabilising mechanism for supporting an electrically insulated screen according to an embodiment of the present invention;

FIG. 7 shows an electrically insulated screen according to an embodiment of the present invention;

FIG. 8 shows an electrically insulated screen according to an embodiment of the present invention;

FIG. 9 shows a plan view of a number of side and end panels for creating a containment area according to an embodiment of the present invention;

FIG. 10 shows a perspective view of a containment area according to an embodiment of the present invention;

FIG. 11 shows a rear view of a straight panel with an overlapping portion according to an embodiment of the present invention;

FIG. 12 shows a front view of a panel according to an embodiment of the present invention;

FIG. 13 shows a top view of a straight panel with an overlapping portion according to an embodiment of the present invention;

FIG. 14 shows a rear view of a straight panel with an overlapping portion according to an embodiment of the present invention;

FIG. 15 shows a front view of a straight panel with an overlapping portion according to an embodiment of the present invention;

FIG. 16 shows a top view of a straight panel with an overlapping portion according to an embodiment of the present invention;

FIG. 17 shows a rear view of a straight panel with an overlapping portion according to an embodiment of the present invention;

FIG. 18 shows a front view of a straight panel with an overlapping portion according to an embodiment of the present invention;

FIG. 19 shows a top view of a straight panel with an overlapping portion according to an embodiment of the present invention;

FIG. 20 shows a rear view of a panel with a right hand side corner overlapping portion according to an embodiment of the present invention;

FIG. 21 shows a front view of a panel with a right hand side corner overlapping portion according to an embodiment of the present invention;

FIG. 22 shows a top view of a panel with a right hand side corner overlapping portion according to an embodiment of the present invention;

FIG. 23 shows a rear view of a panel with a left hand side corner overlapping portion according to an embodiment of the present invention;

FIG. 24 shows a front view of a panel with a left hand side corner overlapping portion according to an embodiment of the present invention;

FIG. 25 shows a top view of a panel with a left hand side corner overlapping portion according to an embodiment of the present invention;

### DETAILED DESCRIPTION OF THE INVENTION

### First Embodiment

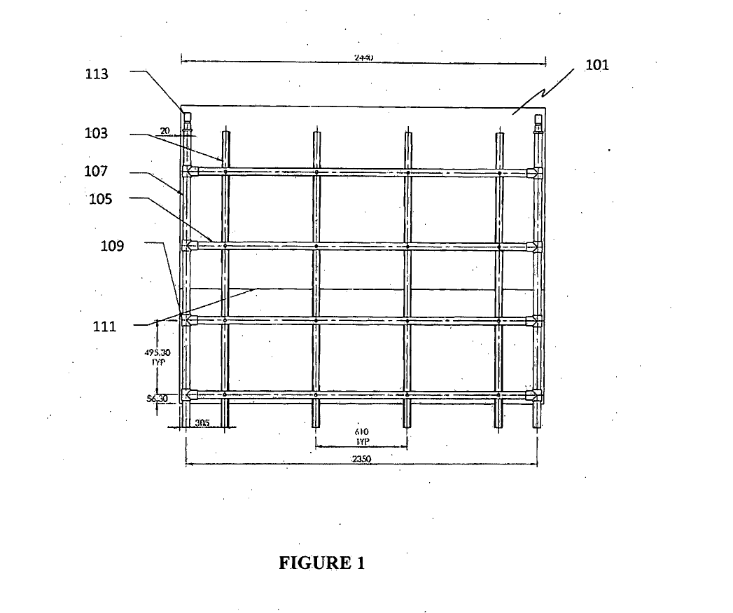

FIG. 1 shows a rear view of an electrically insulated screen, which can be attached to metal scaffolding in order to protect the scaffolding from live electrical cables. That is, the electrically insulated screen is arranged to protect metal scaffolding which is being erected in a defined area where live electrical cables are present and so reduce the risk of the metal scaffolding coming into contact with the live electrical cables.

The electrically insulated screen includes an electrically insulated panel 101, which according to this embodiment is made from an electrically nonconductive material such as reinforced polystyrene. The material used for the panel is tested to overcome AS 4687 requirements, a temporary fencing and hoarding Standard release by Standards Australia as well as AS/NZS 1170. It will be understood that the panel may be tested to overcome any other equivalent or similar Standard or requirement in other jurisdictions.

It will be understood that the panel may be made from other suitable electrically nonconductive materials, such as plastics, ceramics; rubber, carbon fibre, fibre glass, glass (reinforced) or impregnated wood or timber (where the material impregnated into the wood or timber provides electrical resistance to the wood or timber when wet) for example.

Further, the electrically insulated screen includes an electrically insulated frame having several sets of support members as described herein.

The frame has a first set of support members 103 which are arranged in a vertical orientation relative to the surface upon which the scaffolding and electrically insulated screen are being placed.

According to this embodiment the first set of support members 103 are made from a square cross sectional piece of tubing formed from an electrically nonconductive material. For example, according to this embodiment, the support members 103 are made from fibre reinforced plastic (FRP). It will be understood however that the support members 103 may be made from any other suitable electrically nonconductive material.

According to this embodiment, each of the support members 103 is approximately 50 mm in diameter, has a wall thickness of approximately 3.2 mm and has a length of approximately 1980 mm. It will be understood however that other alternative dimensions may be used.

According to this embodiment, the first set of support members 103 includes four separate support members 103 positioned equidistant from each other at approximately 610 mm spacing. It will be understood however that other alternative dimensions may be applied and that there may be less or more support members within the first set.

The frame also has a second set of support members 105 which are arranged in a horizontal orientation relative to the surface upon which the scaffolding and electrically insulated screen are being placed. The horizontal orientation is approximately perpendicular to the vertical orientation of the first set of support members 103.

According to this embodiment the second set of support members 105 are made from a round or circular cross-sectional piece of tubing formed from an electrically nonconductive material. According to this embodiment, the second set of support members 105 are made from fibre reinforced plastic (FRP). It will be understood however that the support members 105 may be made from any other suitable electrically nonconductive material.

According to this embodiment; each of the support members 105 is approximately 50 mm in diameter, has a thickness of approximately 3.2 mm and has a length of approximately 2350 mm. It will be understood however that other alternative dimensions may be applied.

According to this embodiment, the second set of support members 105 includes four separate support members positioned equidistant to each other at approximately 495 mm spacing. It will be understood however that other alternative dimensions may be applied and that there may be less or more support members within the second set.

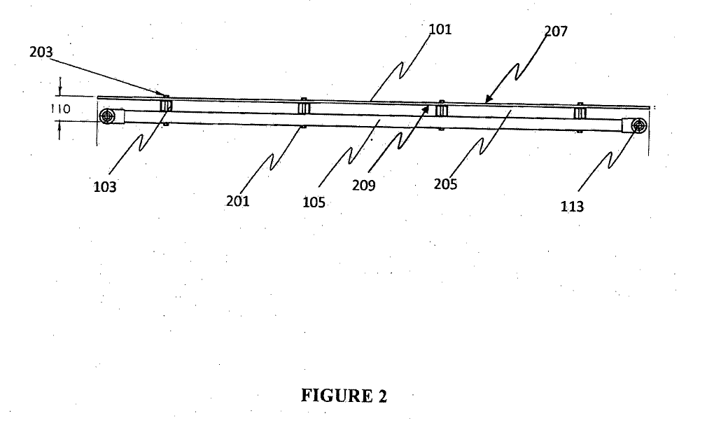

The arrangement of the first and second set of support members provides a criss-cross of supporting elements that support the electrically insulated panel 101. The first set of support members is attached to the second set of support members, where the second set of support members intersects the first set of support members. They are attached using connectors that connect the electrically insulated panel to the electrically insulated frame, as will be explained in more detail below with reference to FIG. 2.

The frame also has a third set of support members 107 also arranged in a vertical orientation in the same way as the first set of support members 103. According to this embodiment, the third set of support members 107 are made from the same material as the second set of support members 105. It will be understood however, that as an alternative, other suitable materials may be used.

Each of the third set of support members 107 is located at an outer position relative to the first set of support members. That is, a first support member of the third set is located on the left-hand side of the first set of support members and a second support member of the third set is located on the right-hand side of the first set of support members.

The second set of support members 105 are connected to the third set of support members 107 via handrail tee clamps 109 also made from a composite material. It will be understood that other suitable electrically insulated (i.e. non-electrically conductive) materials may be used, such as FRP for example.

The electrically insulated screen 101 has a width of approximately 2440 mm, a height of approximately 1220 mm and a thickness of approximately 10 mm. Two screens are provided for attachment to the frame, where the screens are sealed together using silicon sealant at the point 111 where the screens join. It will be understood that, as an alternative, the electrically insulated screen 101 may be made from a single piece of material for attachment to the frame.

Located at the top distal end of each of the support members 107 in the third set is a plastic spigot 113 which is configured to fit into the hollow interior of each of the support members 107. In this way, a further support member may be attached on top of the existing support members 107.

This arrangement therefore provides a modular construction where each portion of the screen including a panel, frame and one or more connectors may be connected to other portions of the screen to form an entire electrically insulated screen arrangement.

Each portion of the screen may be attached to a further portion of the screen by arranging the support members 107 to attach together via the plastic spigots 113. Further, each portion of the screen may be attached to a further portion of the screen at the side by clamping two adjacent support members 107 together using any suitable clamp. Preferably, the clamp is made from an electrically insulated material.

FIG. 2 shows a top view of an electrically insulated screen.

As mentioned above, connectors are used to connect the electrically insulated panel 101 to the frame. It will be understood that any suitable form of connectors may be utilised to connect the panel to the frame.

According to this embodiment, the connectors include a nylon bolt 201 which first passes through an aperture formed in the second set of support members 105 where they intersect with the first set of support members 103. The bolt then passes through an aperture formed in the first set of support members 103, and finally through the panel 101 where the bolt is attached to one or more nylon nuts 205. Alternatively, it will be understood that the bolt may be passed through the support members and panel in the opposite direction such that the nylon nut is attached on the side of the frame.

Further, it will be understood that alternative materials to nylon may be used for the connectors, such as fibre glass, ceramic, carbon fibre, rubber and glass (reinforced).

The first set of support members is placed up against or adjacent to the surface of the panel. Therefore, the first set of support members 103 provides a mechanism for spacing the panel away from the second set of support members 105. In this manner, the arrangement of the first set of support members 103 ensures that a gap 205 exists between the panel 101 and the second set of support members 105, where this gap is used to attach the screen to the scaffolding.

The electrically insulated panel 101 has an outer surface 207 and an inner surface 209, where the panel is arranged such that the outer surface is on the side of the live electrical cables when the screen is erected, and the inner surface is on the side of the scaffold when the screen is erected.

The gap between the panel and the second set of support members 105 enables a clamp to pass around and engage the frame and attach the screen, via the second set of support members, to the scaffold (not shown). That is, the clamp attaches the second set of support members to the scaffolding.

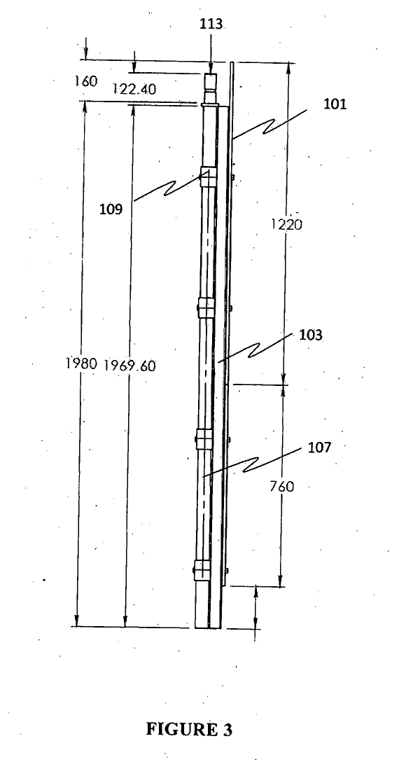

FIG. 3 shows a side view of an electrically insulated screen. According to this view, it can be seen that the upright support members 103 are positioned in between the panel 101 and the horizontal support members 105 (not shown), where it will be understood that the horizontal support members 105 are positioned just behind the third set of support members 107 according to this view.

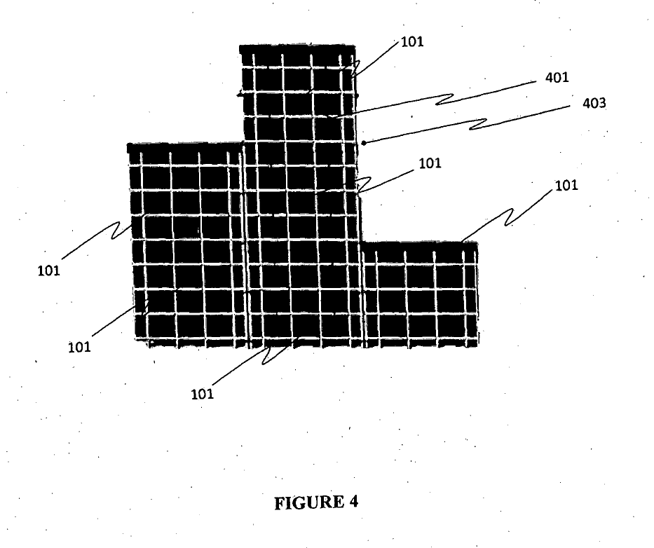

FIG. 4 shows a perspective view of erected electrically insulated screens. According to this view, it can be seen that six separate modular electrically insulated screens 401 have been interconnected to form a barrier that may be used to protect scaffolding (not shown) from electrically live cables. The screens include clamps 401 to attach the frame to the scaffolding. Further, screens also include further clamps 403 to enable the individual screens to be attached to further screens at the side.

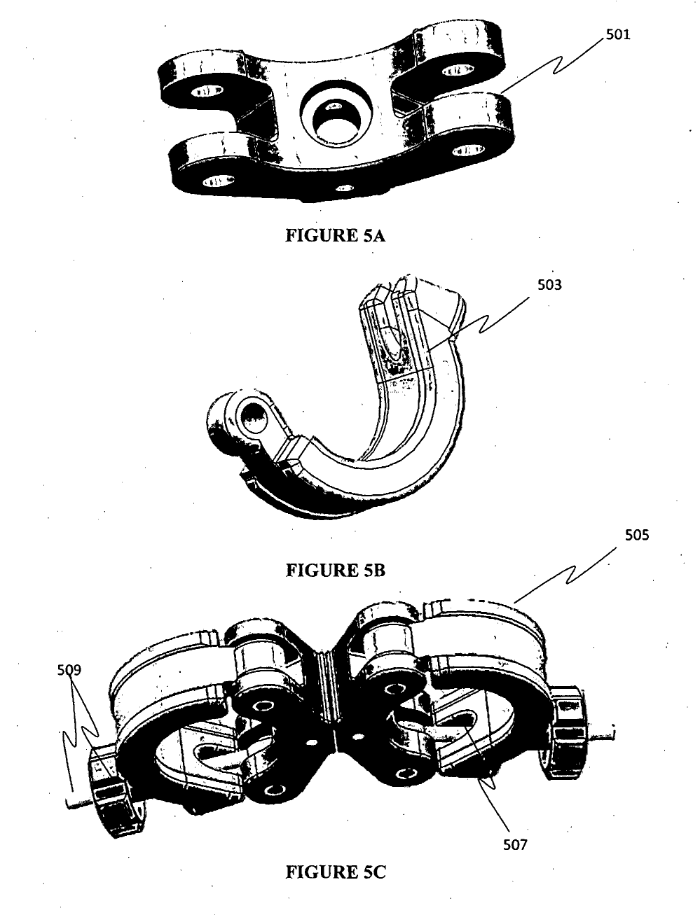

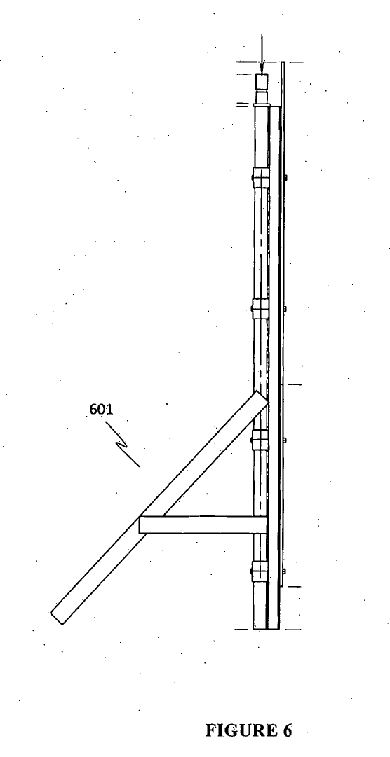

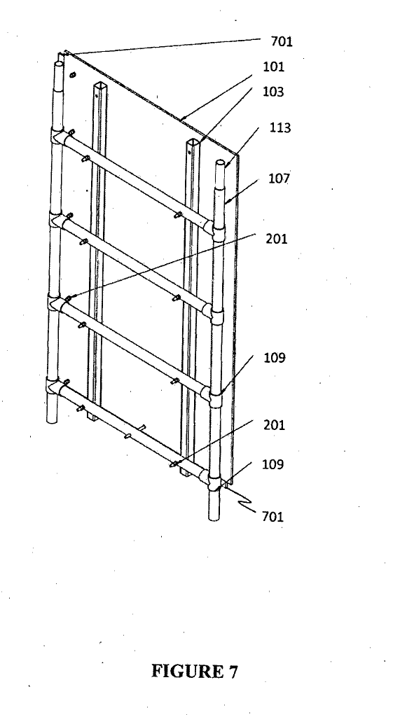

FIGS. 5A, 5B and 5C show an example of a clamp mechanism that may be used to connect the frame to the scaffolding as well as for connecting the individual screens to further screens at the side.

A first clamp piece 501 made from PVC (or any other suitable electrically non-conductive material as described herein elsewhere) is interconnected with a second clamp piece 503 to form a clamp mechanism 505. Each of the clamp pieces are connected together using a screw mechanism that is connected to and pivots relative to the first clamp piece, and locks against the second clamp piece after passing through a channel 507 formed through the second clamp piece.

As can be seen in FIG. 5C, two opposing substantially C-shaped first clamp pieces are attached to each other via suitable nut and bolt connector passing through the apertures on the first clamp pieces. Each of these first clamp pieces are interlocked with a second clamp piece at a first end, to enable the second clamp piece to pivot relative to the first clamp piece. The second end of the first clamp piece has connected thereto a first portion of the locking mechanism 509, which pivots relative to the first clamp piece. The second end of the second clamp piece is locked against the second end of the first clamp piece by pivoting the locking mechanism 509 into the channel 507 of the second clamp piece and locking the locking mechanism.

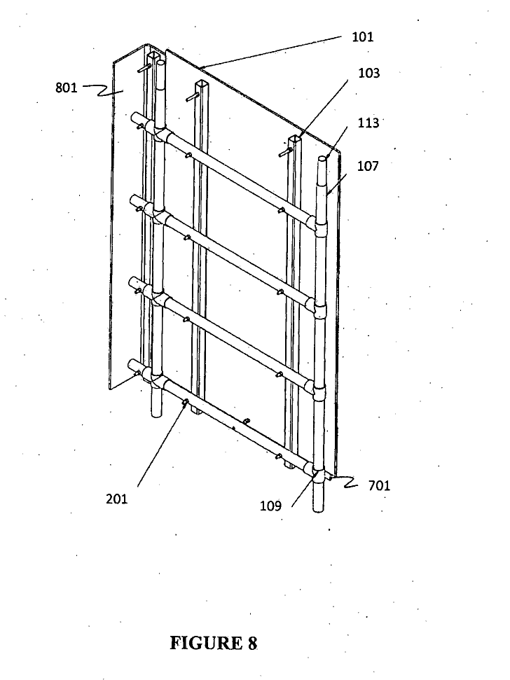

FIG. 6 shows a stabilising mechanism 601 for supporting an electrically insulated screen prior to or during installation of the scaffolding according to the herein described method.

The stabilising mechanism 601 includes a first stabilising member that attaches to one of the support members of the frame using any suitable clamp. It will be understood that the first stabilising member may be attached to any one of the first second or third sets of the support members. The first stabilising member then projects downwards from the frame to the ground at an angle of approximately 45°. A second stabilising member is provided to provide support to the first stabilising member. The second stabilising member is clamped at a first end to the first stabilising member approximately halfway along the first stabilising member's length. The second end of the second stabilising member is clamped to the frame. It will be understood that alternative arrangements may be used to provide stabilising means to initially support the screen as it is installed. According to this embodiment, the stabilising members are also made from FRP. It will be understood however that the stabilising members may be made from any other suitable material.

A method of erecting the screen as described herein is provided in order to protect the scaffold from live electrical cables in a defined area. The method has a number of steps as described below.

One or more portions of the screen are initially erected prior to erecting the scaffolding. Subsequently, the scaffolding is erected on the side of the screen that is opposite to the side of the screen where the live electrical cables are located. It is always ensured that the height of the screen is always greater than the height of the scaffold being erected. That is, a screen portion is always erected prior to erecting the scaffolding.

Therefore, in more detail, a first portion of the screen is erected to an initial height along an initial length in a defined area where the electrical cables exist.

A stabilising mechanism 601 is then attached or fixed to this first portion of the erected screen.

Once this first portion of the screen has been erected and the stabilising mechanism has been attached a first portion of scaffolding may then be erected to a height and length that is less than the height and length of the erected screen.

That is, during this procedure, the height of the scaffolding does not exceed the height of the screen, the length of the scaffolding does not exceed the length of the screen and the scaffolding is erected on the side of the screen that is opposite to the side where the live electrical cables are located.

Once the initial portion of the screen has been erected and the initial portion of the scaffolding has been erected the screen may be attached to the scaffolding using clamps as described above. After the screen has been attached to the scaffolding, the stabilising mechanism may be removed. That is, the stabilising mechanism is only required during the initial stages of erecting the first portion of the screen to ensure the screen remains stable while erecting the scaffolding.

If the width of the first portion of the screen is sufficient to protect the scaffolding from the live electrical cables along the horizontal axis, it is then only necessary to increase the height of the screen in order to protect the scaffolding from the cables along the vertical axis. That is, a second portion of the screen may be added to the first portion of the screen by placing the second portion on top of the first portion by connecting the third sets of support members via the plastic spigots.

It will be understood that the most common arrangements will likely require the screen to be increased in length (along the horizontal axis) prior to increasing the screen in height (along the vertical axis). In this situation, further portions of the screen may be attached to the existing screen by clamping the outermost vertical support members to each other using suitable clamps. Preferably, two clamps are used on each side of each screen. However, it will be understood that a single clamp may be used or more than two clamps may be used.

Therefore, the outermost upright support members (i.e. the third set of support members) on adjacent screens are clamped together. During the extension of the length of the screen, the erection of the scaffolding may be continued as long as its height and length do not exceed the height and length of the screen.

Optionally, where further screens are attached to existing screens a sealant may be provided in between the screens, such as a silicon sealant.

After the complete length of the screen has been erected, further screen portions may be positioned on top of the existing screen portions to increase the height of the screen.

That is, the people erecting the screen may stand upon the scaffold platform and have the further screen portions passed up to them on the safe side of the screen (i.e. the side opposite to the electrical cables) so that they may then erect one or more further screen portions on top of the existing erected screen. It will be understood that the further screen portions may be passed up to the people erecting the screen using any suitable mechanism, such as a pulley system, lanyards or rope. Further, a rolling hitch may be used as an additional safety measure in case the screen is dropped.

According to this embodiment, it is ensured that the difference in height between the screen and the scaffold is no less than 1 m to meet required safety requirements. However, it will be understood that other differences in height may be used such as, for example, no less than 50 cm.

Therefore, according to the system, a safe and secure environment is provided when erecting scaffolding in a defined area where there are live electrical cables. This therefore means that electrical cables do not need to be disconnected from their power supply prior to the erection of scaffolding in that defined area.

It will be understood that, the embodiments of the present invention described herein are by, way of example only, and that various changes and modifications may be made without departing from the scope of invention.

According to a further embodiment, additional portions may be attached to or formed on the electrically insulated panel 101 in order to cause an overlap 701 along the lower edge (and/or upper edge) and/or along a side edge of the panel, as shown in FIG. 7. For example, the overlap may be in the order of 50 mm to ensure that there is no gap in between adjacent panels. It will be understood that, as an alternative, the overlap may be less or greater than 50 mm. The additional portions may be attached to the virtually insulated panel using any suitable methods such as clamping the additional portion to the panel or attaching the additional portion using an attachment device. For example, the additional portion may be made from any suitable electrically non-conductive material. For example, the additional portion may be flexible or stiff. For example, the additional portion may be made from reinforced polystyrene or a foamed plastic material. Additional sheets if needed may be screwed into the panel to close gaps etc.

According to a further embodiment, the dimensions of the panel may vary. For example, the width of the panel may be in the order of 600 mm, 754 mm or 1210 mm. It will be understood that other suitable widths more or less than those stated above may also be used. Further, the height of the panel may also vary dependent upon the requirements of the user.

Further, it will be understood that as an alternative embodiment, the first set of support members are not required to be positioned equidistant from each other. For example, the support members may be positioned at different distances from each other. For example, where the width of the panel is 1210 mm, there may be two support members where a first support member is positioned approximately 240 mm from the left side support member (third set) and a second support member is positioned approximately 240 mm from the right side support member (third set). Other alternative positioning distances are envisaged for panel widths of 754 mm and 600 mm, such as 143 mm and 110 mm from the third set of support members.

According to yet a further embodiment, a corner portion 801 may be formed on or attached to the electrically insulated screen, as shown in FIG. 8. For example, extension frame pieces may be attached to the lateral portions, of the frame. Additional lateral frame portions may then be attached to the extension pieces extending in a direction substantially perpendicular to the existing frame to form a right angle. Further, upright frame portions may then be attached to the lateral frame portions to form the additional frame. An additional panel portion may then be attached to this additional frame in the same manner as described above. In this manner, a corner is formed to enable the electrically insulated screen to extend around an area (e.g. to circumvent an area). The corner portions may be attached to either the left hand side or right hand side of the existing screen: For example, the corner portion may be made from any suitable electrically non-conductive material. For example, the corner portion may be flexible or stiff. For example, the additional portion may be made from reinforced polystyrene or a foamed plastic material. In addition, an overlapping lower portion 701 may also be included similar to that shown in FIG. 7.

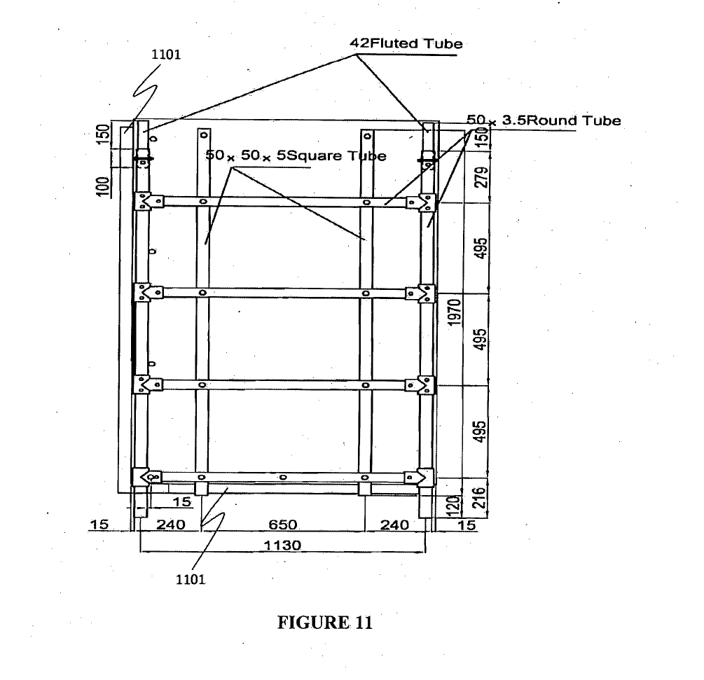

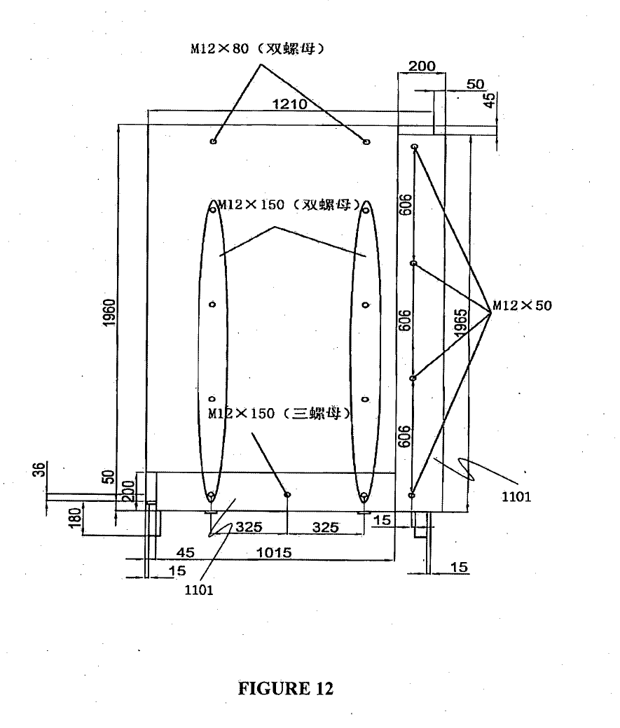

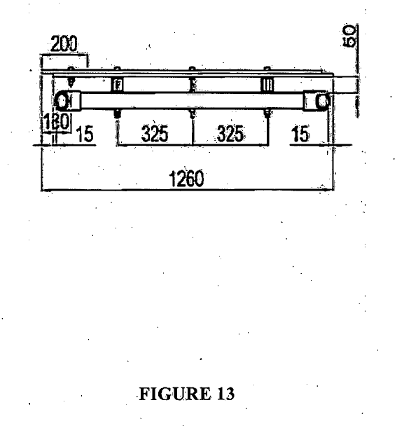

Various examples of screen configurations are provided in the accompanying drawings as follows. FIG. 11 shows a rear view of a first example straight panel with overlapping portions 1101. FIG. 12 shows a front view of the panel. FIG. 13 shows a top view of the panel.

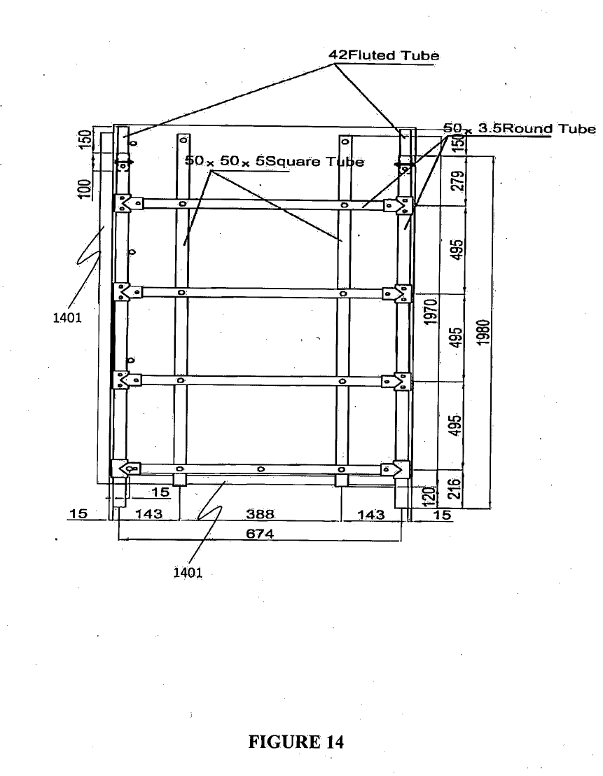

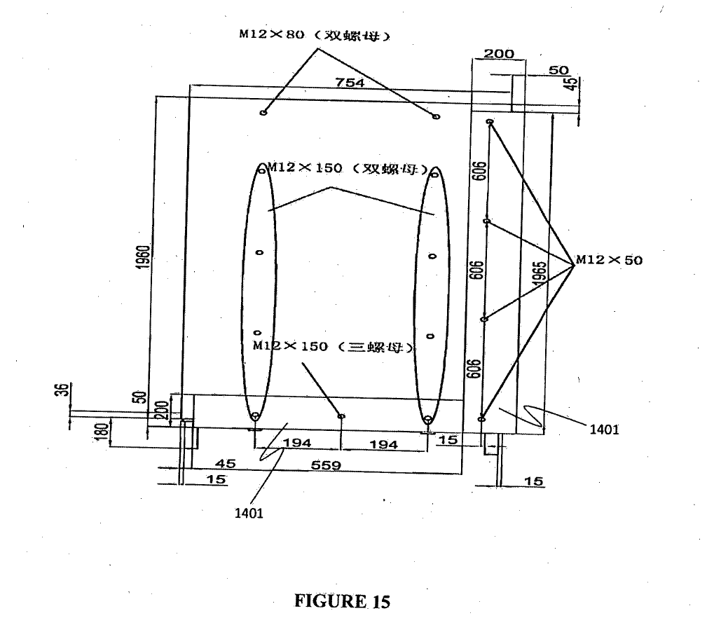

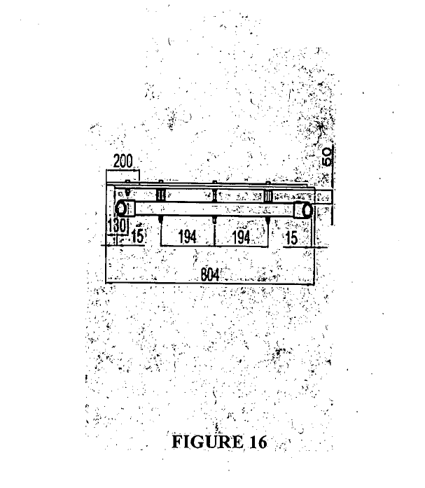

FIG. 14 shows a rear view of a second example straight panel with overlapping portions 1401. FIG. 15 shows a front view of the panel. FIG. 16 shows a top view of the panel.

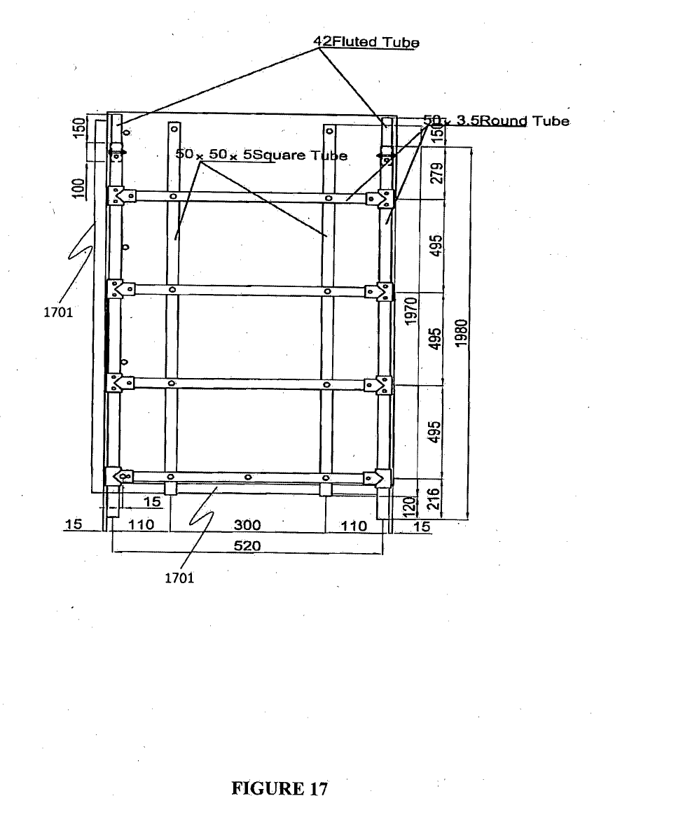

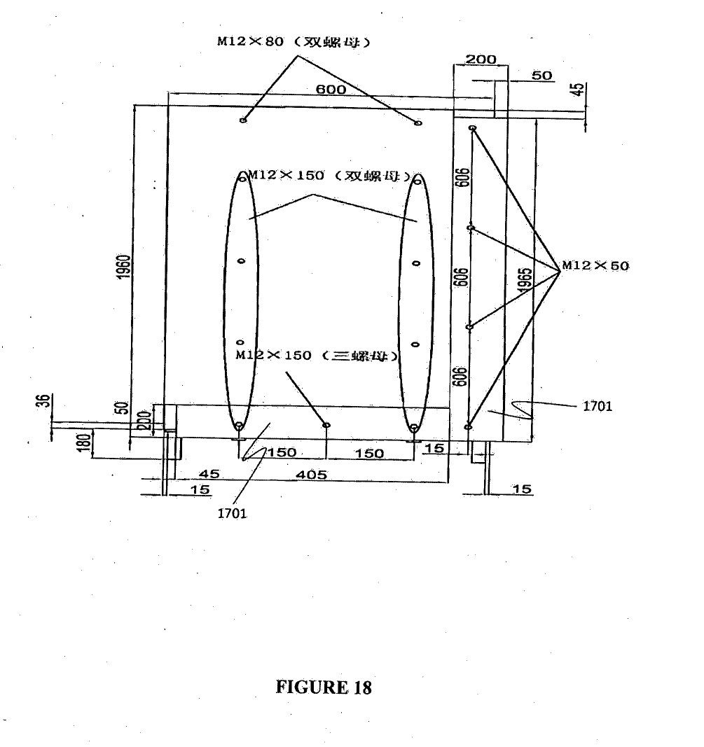

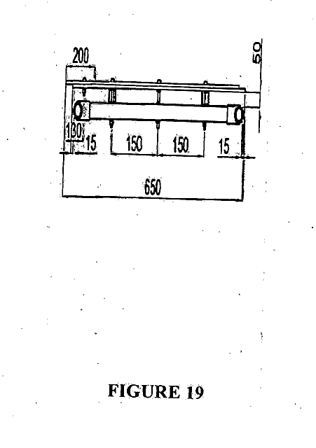

FIG. 17 shows a rear view of a third example straight panel with overlapping portions 1701. FIG. 18 shows a front view of the panel. FIG. 19 shows a top view of the panel.

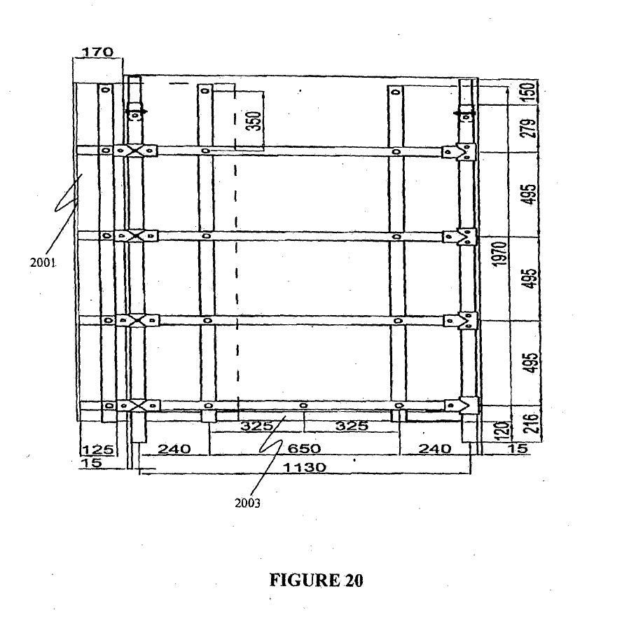

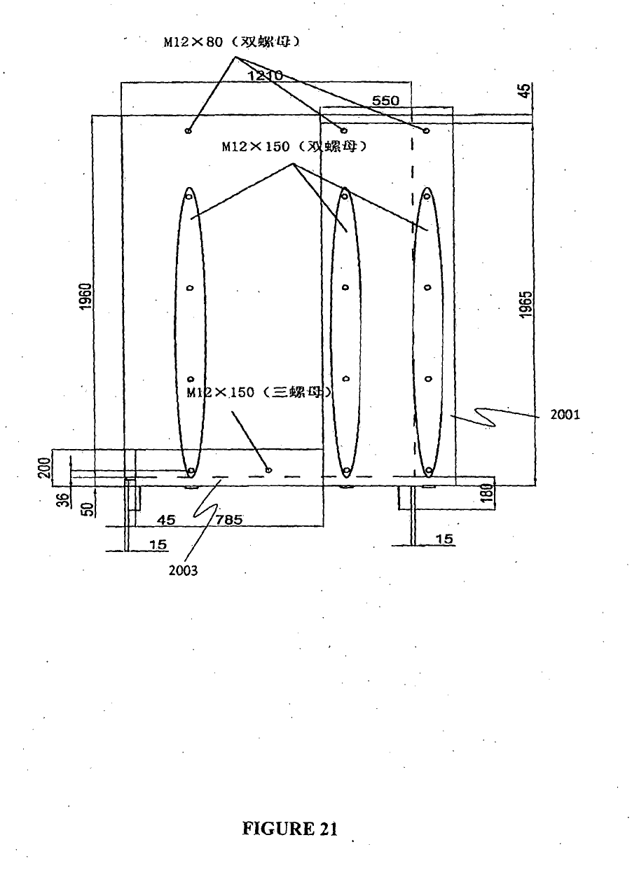

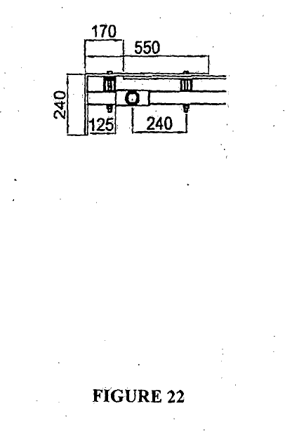

FIG. 20 shows a rear view of a panel with a right hand side corner overlapping portion 2001 and lower overlapping portion 2003. FIG. 21 shows a front view of the panel. FIG. 22 shows a top view of the panel.

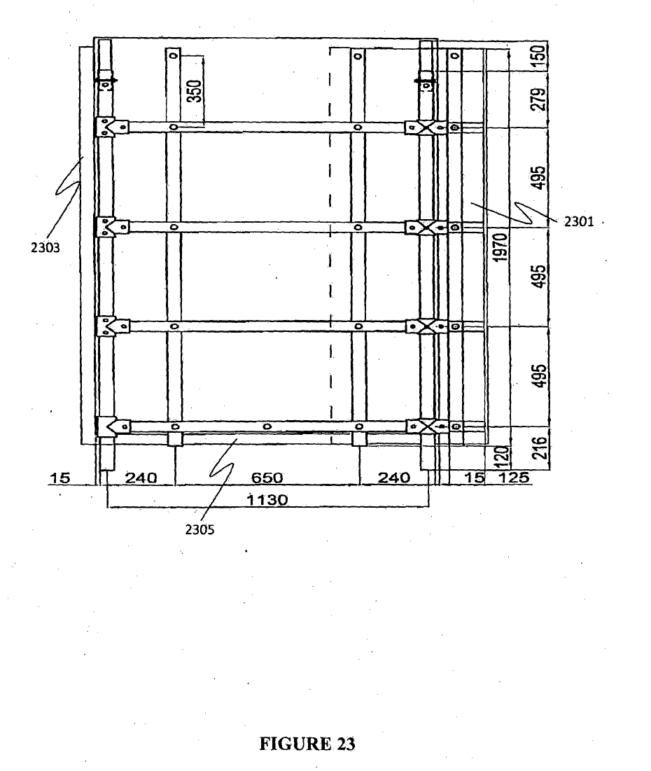

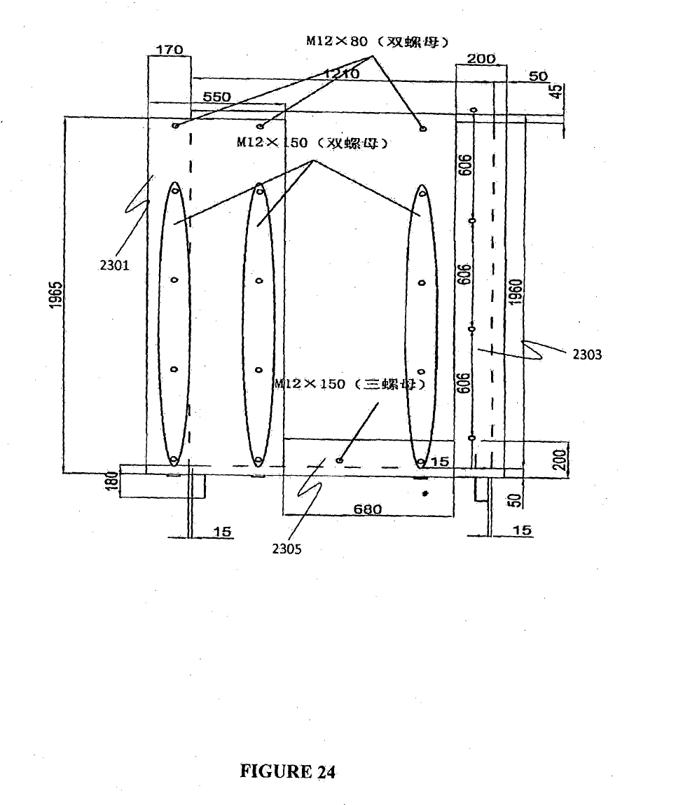

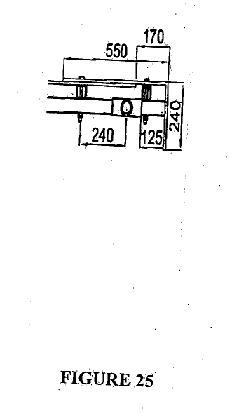

FIG. 23 shows a rear view of a panel with a left hand side corner overlapping portion 2301, a right hand overlapping portion 2303 and a lower overlapping portion 2305. FIG. 24 shows a front view of the panel. FIG. 25 shows a top view of the panel.

It will be understood that different sizes of panels, corner portions and other overlapping portions may be used where and when required.

It will be understood that the materials of the various components described herein may be modified as long as they still meet the required safety regulations.

Further, it will be understood that the first set of support members may have a circular cross-section and the second set of support members may have a square cross-section.

According to yet a further embodiment, the screens as described herein may be used to create a containment area as defined by the boundary or perimeter of a scaffolding system.

For example, the system may completely encapsulate the scaffold, the scaffold may be completely enclosed, and air-condition may be placed within the enclosed area to ventilate the work area and improve the work area for all involved.

According to this embodiment, a scaffolding system is erected using standards, ledgers and transoms along with braces and all other required components to make the scaffolding safe. After or during erection of the scaffolding, a containment area is created by attaching various screens to the scaffolding. It will be understood that the screens may be attached prior to the erection of the scaffolding being completed. That is, the screens may be attached at the same time as erecting the scaffolding, for example as each side of the scaffolding has been completed. This system could also be used on any suitable frame structure for example structural steel not only on a scaffold structure.

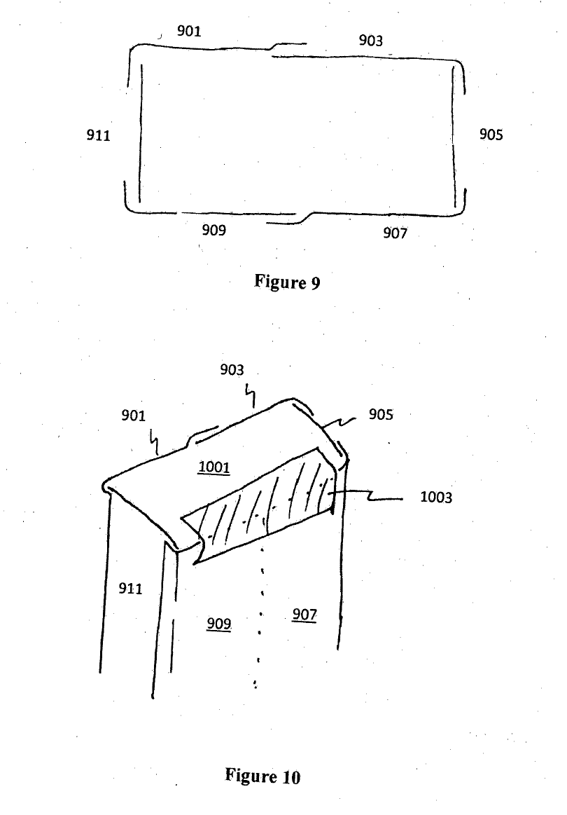

FIG. 9 shows a plan view of the arrangement of screens when attached to a scaffolding system. For clarity purposes, the scaffolding system itself is not shown in FIG. 9, however it will be understood that the scaffolding system will be enclosed within the boundaries of the screens shown.

According to this embodiment, the containment area is two screens wide and one screen deep. A first side panel 901 of a first side screen includes a corner portion, a flat portion and an overlapping portion, where the overlapping portion overlaps a flat portion of a second side panel 903 of a second side screen. The second side panel 903 also includes a corner portion which overlaps with a first end panel 905 of a third side screen.

A third side panel 907 of a fourth side screen includes a corner portion that overlaps with the first end panel 905. This side panel 907 may form at least part of a corner screen. The third side panel 907 also includes a flat portion and an overlapping portion, where the overlapping portion overlaps a flat portion of a fourth side panel 909 of a fifth side screen. The fourth side panel 909 also includes a flat portion and a corner portion, where the corner portion overlaps a second end panel 911 of a sixth side screen. The corner portion of the first side panel 901 also overlaps the second end panel 911.

Therefore, six vertically orientated panels of the six side screens create the walls of the containment area. According to this embodiment, each of the overlapping portions and corner portions are attached to the corresponding flat portion of the neighbouring panel using non-electrically conductive attachment elements such as bolts or screws. However, it will be understood that, in environments where the panels are not required to be electrically insulated the attachment elements may be made from any suitable material including electrically conductive materials. Further, as an alternative, it will be understood that in environments where the panels are not required to be electrically insulated, the panels may be made from any suitable material including materials that could potentially be electrically conductive.

It will be understood that the screens may be attached to the scaffolding system using the attachment mechanisms described above.

As an option, any gap between the overlapping or corner portions of the side panels and the neighbouring flat portions may be sealed using any suitable sealing material. The sealing material may be non-electrically conductive. However, in environments where it is not a requirement for all components to the electrically insulated, the sealing material may potentially be electrically conductive.

To enable persons to enter or exit the containment area, one or more of the vertically orientated panels may include an exit or entry port. For example, the exit or entry port may be a hinged door, a sliding door or a breakable section. For example, the breakable section may be arranged to be broken away from the main portion of the panel in cases of emergency.

FIG. 10 shows a top panel 1001 being attached to the walls of the containment area according to this embodiment. The top panel is arranged to sit upon the transoms of the scaffold in a horizontal manner so that the edge of the top panel is aligned with the edges of the vertically orientated panels described above. A foamed plastic material 1003, such as a flexible PVC material for example, is attached to the top panel 1001 and the side panels 907 and 909 so that the foamed plastic material 1003 seals the edge between the top panel and the side panels. The foamed plastic material may be attached using any suitable attachment elements, such as bolts or screws. Alternatively, the foamed plastic material may be attached using glue or a sealant, for example. In the case of using a sealant, the sealant may be required to be an electrically insulated sealant, but in environments where it is not a requirement that all components are to be electrically insulated, the sealing material may be electrically conductive.

Further foamed plastic material may be attached to cover the edges between the top panel and end panels as well as the opposing edge between the top panel and side panels 901 and 903. Therefore, the perimeter at the top of the containment area is sealed using the foamed plastic material. Further, if sealing materials are used, the containment area may be made airtight.

Further, at least one of the vertically orientated panels in the vertically orientated screens may have an aperture formed therein for receiving an air-conditioning unit. The air-conditioning unit may then be installed within the aperture to provide air-conditioning within the containment area. A seal may be provided around the perimeter of the aperture to enable the air-conditioning unit to work more efficiently and/or to provide an airtight seal around the air-conditioning unit.

As an alternative, it will be understood that the top panel may include corner portions arranged to pass over the end panels or side panels to assist in sealing the containment area.

Further, it will be understood that the size of the containment area may be adjusted according to the requirements of the users of this system. That is, there may be any number of side portions connected together including multiple top panels interconnected to form the top portion of the containment area. The multiple top panels may have overlapping portions and/or corner portions in order to assist in sealing the containment area. Further, the multiple top panels may be sealed using any suitable sealant as described above or may have foamed plastic material placed over the interconnecting areas of the panels to interconnect the panels and/or seal the containment area.

Further, it will be understood that the containment area may be built using panels that are not electrically insulated. For example, in an area where there is no risk of electrocution, aluminium panels may be used to form the containment area in a similar way as described above. Other alternative materials may also be used. According to this alternative, it will also be understood that the attachment elements, seals and interconnecting portions are not required to be made from electrically insulated material.

Further, it will be understood that as an alternative to an air-conditioning system, a fan unit may be installed. The fan unit may include a filter system for filtering air coming in or leaving the containment area. Alternatively, other air systems may be used such as a vacuum system or, exhaust stack etc.

Further, although various embodiments herein relate principally to insulating a metal scaffold from electrical wires as metal scaffolding is the typical material used to manufacture scaffolding, it will be understood that the same principals described herein can be applied to a scaffold constructed from non-conductive materials such as structural grade plastic or reinforced fibreglass, which in themselves are nonconductive, thereby producing a safer scaffold than one which in which the structural members are metal.

1. A method of erecting an electrically insulated screen for a metal scaffold in a defined area with live electrical cables, the method comprising the steps of:
erecting a first portion of the screen to a first screen height along a first screen length in the defined area;
affixing the first portion of the screen in place using a stabilising mechanism; and
after affixing the first portion of the screen, erecting a first portion of the scaffold to a first scaffold height and a first scaffold length, wherein:
the first scaffold height does not exceed the first screen height,
the first scaffold length does not exceed the first screen length, and
the first portion of the scaffold is erected on a side of the first portion of the screen that is opposite to a side where the live electrical cables are located, and the screen is attached to, and electrically insulated from, the scaffold.

2. The method of claim 1, further comprising the steps of:
attaching a second portion of the screen on top of the first portion of the screen to extend the height of the screen to a second screen height;
erecting a second portion of the scaffold to a second scaffold height where the second scaffold height does not exceed the second screen height.

3. The method of claim 2, further comprising the step of applying an electrically insulated sealant at the junction where the first and second portions of the screen meet.

4. The method of claim 1, further comprising the steps of:
attaching a second portion of the screen to the first portion of the screen prior to erecting the first portion of the scaffold, wherein the second portion of the screen is attached to the side of the first portion of the screen at the first screen height along a second screen length, and
erecting the first portion of the scaffold to the first scaffold height and a second scaffold length that combines the first and second screen lengths.

5. The method of claim 4, further comprising the step of applying an electrically insulated sealant at the junction where the first and second portions of the screen meet.

6. The method of claim 4, further comprising the steps of attaching further portions of the screen to the existing screen portions prior to erecting further portions of the scaffold while ensuring that the height of the screen is greater than the height of the scaffold.

7. The method of claim 1, where the difference in height between the first screen height and the first scaffold height is no less than 50 cm.

8. The method of claim 7, where the difference in height between the first screen height and the first scaffold height is no less than 1 metre.

9. The method of claim 1, further comprising the step of attaching the first portion of the screen to the first portion of the scaffold after the first portion of the scaffold has been erected.

10. The method of claim 9, further comprising the step of removing the stabilising mechanism after the first portion of the screen has been attached to the first portion of the scaffold.

11. The method of claim 9, further comprising the step of attaching the first portion of the screen to the first portion of the scaffold using an electrically insulated damp.

12. The method of claim 11, further comprising the step of attaching the damp to a frame forming at least part of the screen.

13. The method of claim 12 further comprising the step of attaching the damp to a side of the screen that is opposite to a side where the live electrical cables are located.

14. The method of claim 12, further comprising the step of attaching the damp through a gap formed in between at least a portion of the frame and a surface of the screen.

15. A method of erecting an electrically insulated screen for a metal scaffold in a defined area with live electrical cables, the method comprising the steps of erecting one or more portions of the screen and subsequently erecting one or more portions of the scaffold, while ensuring that the height of the screen is greater than the height of the scaffold and ensuring that the scaffold is erected on a side of the first portion of the screen that is opposite to a side where the live electrical cables are located, wherein the screen is attached to, and electrically insulated from, the scaffold.

16. An electrically insulated screen for protecting a metal scaffold from coming into account with live electrical cables in a defined area with the live electrical cables, wherein the screen comprises:
an electrically insulated panel,
an electrically insulated frame,
one or more connectors to connect the panel to the frame, wherein the connectors are arranged to connect the panel to the frame to form a gap between the frame and the panel, wherein the gap is used by an attachment device to engage the frame and attach the screen to the scaffold.

17. The electrically insulated screen of claim 16, wherein the screen is of a modular construction such that each portion of the screen comprising the panel, the frame and one or more connectors can be connected to another portion of the screen either at the top or at the side, or both.

18. The electrically insulated screen of claim 16, wherein the electrically insulated panel is formed from an electrically nonconductive material selected from one or more of: polystyrene, plastic, ceramic, rubber, carbon fibre, fibre glass, glass, or impregnated wood or timber.

19. The electrically insulated screen of claim 16, wherein the electrically insulated panel includes an outer surface and an inner surface, where the panel is arranged such that the outer surface is on the side of the live electrical cables when the screen is erected, and the inner surface is on the side of the scaffold when the screen is erected.

20. The electrically insulated screen of claim 16, wherein the connectors are arranged to connect the panel to the frame while ensuring a gap exists between the inner surface of the panel and at least a portion of the frame.

21. The electrically insulated screen of claim 20, wherein the connector comprises a nut and a bolt, wherein a first plurality of support members provides the gap between the inner surface of the panel and a portion of the frame.

22. The electrically insulated screen of claim 16, wherein the connectors are formed from electrically insulated components.

23. The electrically insulated screen of claim 22, wherein the electrically insulated components are formed from a material consisting of at least one of: plastic; nylon, rubber, carbon fibre, fibre glass or glass (reinforced).

24. The electrically insulated screen of claim 16, wherein the electrically insulated frame further comprises a first plurality of support members arranged in a first orientation and a second plurality of support members arranged in a second orientation, wherein the second orientation is substantially perpendicular to the first orientation.

25. The electrically insulated screen of claim 24, further comprising a third plurality of support members arranged in the first orientation, wherein the third plurality of support members are arranged to interconnect with a further electrically insulated screen via a further third plurality of support members.

26. The electrically insulated screen of claim 25, wherein the electrically insulated screen further comprises at least two spigots attached to an upper end of at least two of the third plurality of support members, wherein each spigot is adapted to connect to the bottom of at least two of the further third plurality of support members to interconnect the third plurality of support members and the further third plurality of support members.

27. The electrically insulated screen of dam 26, wherein the at least two of the third plurality of support members are the two outer most support members.

28. The electrically insulated screen of claim 25, further comprising clamps arranged to connect a further electrically insulated screen to the side of the electrically insulated screen by damping one of the third plurality of support members on the electrically insulated screen to one of the further third plurality of support members on the further electrically insulated screen.

29. The electrically insulated screen of claim 24, wherein the connectors are arranged to connect the panel to the first plurality of support members.

30. The electrically insulated screen of claim 24, wherein the second plurality of support members are arranged to connect the screen to the scaffold.

31. The electrically insulated screen of claim 24, wherein the first plurality of support members has a substantially square cross section.

32. The electrically insulated screen of claim 24, wherein the second plurality of support members has a substantially round cross section.

33. The electrically insulated screen of claim 16, further comprising one or more overlap or corner portions.

34-54. (canceled)
